(19) United States
(12) Patent Application Publication
(10) Pub. No.: US 2019/0015689 A1
(43) Pub. Date: Jan. 17, 2019

(54) FIRE EXTINGUISHERS WITH PRESSURE NEUTRALIZED INTERNAL PLATES

(71) Applicant: Kidde Technologies, Inc., Wilson, NC (US)

(72) Inventor: Mark P. Fazzio, Wilson, NC (US)

(21) Appl. No.: 15/650,024

(22) Filed: Jul. 14, 2017

(51) Int. Cl. A62C 13/00; A62C 13/68

(52) U.S. Cl. CPC A62C 13/003; A62C 13/68

(57) ABSTRACT

A fire extinguisher includes a main dome surrounding an interior. An internal plate is mounted inside the interior of the main dome, dividing the interior into an internal space housing agent and a secondary internal space. The internal space housing agent and the secondary internal space are both pressurized above ambient. The secondary internal space is free of agent, and can be pressurized, e.g., to no less than the total pressure of the internal space housing agent.

### BACKGROUND OF THE INVENTION

### 1. Field of the Invention

The present disclosure relates to fire extinguishers, and more particularly to fire extinguishers for aerospace applications.

### 2. Description of Related Art

Traditional aircraft fire extinguishers utilize a sphere filled with liquefied extinguishing agent that is expelled through a discharge head at or near the bottom of the spherical container. During discharge, the liquefied agent is driven down and out of the container by the combined agent vapor pressure and a super-pressurizing gas. These containers typically require customized brackets with supports or plates which interface with mounting lugs on the container, typically along the equator thereof. Designs which locate the discharge head outlets further up the side of the container limit the mass of the liquefied agent which is expelled. A dip-tube can be used to increase agent utilization for such designs. However, the dip-tubes present issues with respect to manufacturability and reliability.

The conventional techniques have been considered satisfactory for their intended purpose. However, there is an ever present need for improved fire extinguishers. This disclosure provides a solution for this problem.

### SUMMARY OF THE INVENTION

A fire extinguisher includes a main dome surrounding an interior. An internal plate is mounted inside the interior of the main dome, dividing the interior into an internal space housing agent and a secondary internal space. The internal space housing agent and the secondary internal space are both pressurized above ambient.

The secondary internal space can be free of agent. The internal plate can be welded to the main dome, e.g. internally welded. The internal plate and the main dome can include stainless steel, aluminum, titanium, or composites. The main dome can be spherical. The main dome can be cylindrical, e.g. either horizontally or vertically.

A discharge outlet can be positioned closer to the internal plate than to an apex of the main dome opposite the internal plate. The discharge outlet can be configured to discharge laterally relative to an axis of symmetry of the main dome and the internal plate. The discharge outlet can be positioned to discharge all or almost all of the agent without a dip-tube extending into the interior of the main dome.

The internal plate can divide the interior of the main dome in half. The internal plate can divide the interior of the main dome such that the agent filled space can be more or less than half. The secondary internal space can be pressurized to less than, equal to, or greater than the total pressure of the internal space housing agent. The internal plate can be designed to support the pressure differential which may exist across it throughout the temperature range. The internal plate can include a burst disc configured to rupture when agent is discharged from the internal space housing agent to equalize pressure across the internal plate.

One or more mounting lugs can be mounted to the main dome opposite the internal space housing agent. One or more mounting lugs can be mounted to the main dome surrounding the internal space housing agent. Other components may be attached to the main or secondary domes, including items to fill, vent or monitor conditions of the extinguisher.

A method of fire extinguishing includes storing fire extinguishing agent at pressure inside a main dome of a fire extinguisher wherein a first internal space inside the main dome houses the agent and a secondary internal space inside the main dome is pressurized to balance pressure across an internal plate that separates the internal space housing agent from the secondary internal space. The method also includes discharging all or almost all of the agent through one or more outlet fittings which may be positioned laterally. The method can include rupturing a burst disc while discharging the agent from the internal space housing agent to equalize pressure across the internal plate to render the main dome inert after discharging stops.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic cross-sectional elevation view of an exemplary embodiment of a fire extinguisher constructed in accordance with the present disclosure, showing the internal plate within the main dome;

FIG. 2 is a partially cross-sectional perspective view of the fire extinguisher of FIG. 1, showing a spherical embodiment of the fire extinguisher with the cross-section shown in FIG. 1; and

FIG. 3 is a cross-sectional perspective view of another exemplary embodiment of a fire extinguisher that is cylindrical with the cross-section shown in FIG. 1.

### DETAILED DESCRIPTION OF THE PREFERRED EMBODIMENTS

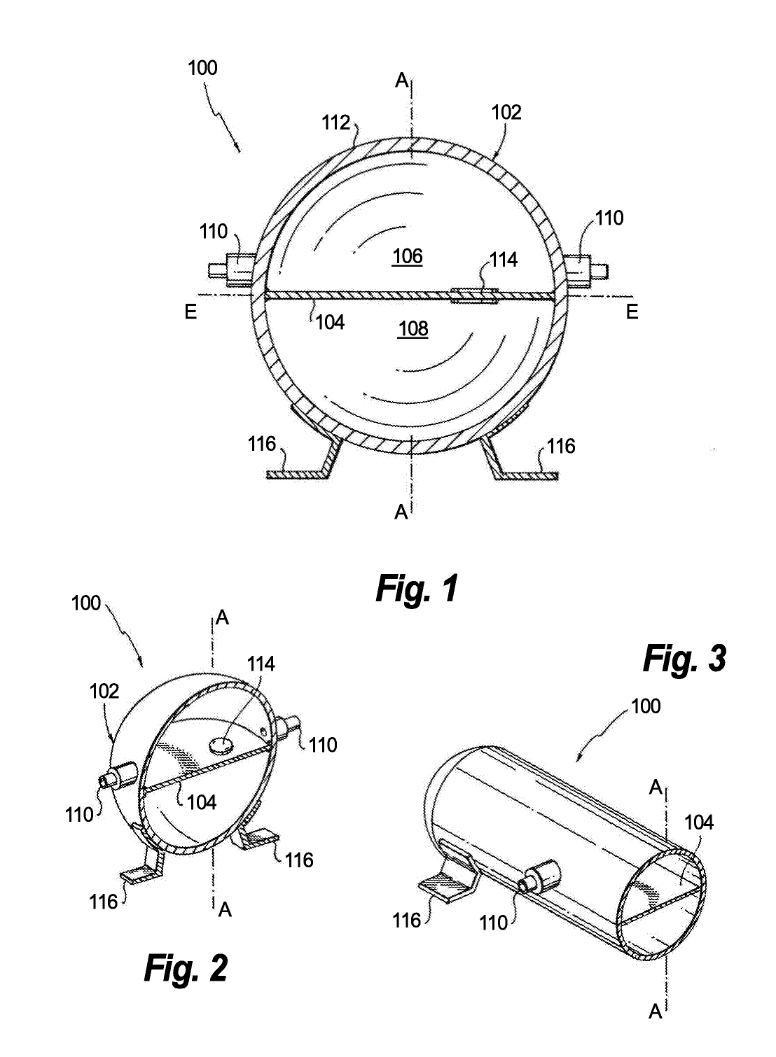

Reference will now be made to the drawings wherein like reference numerals identify similar structural features or aspects of the subject disclosure. For purposes of explanation and illustration, and not limitation, a partial view of an exemplary embodiment of a fire extinguisher in accordance with the disclosure is shown in FIG. 1 and is designated generally by reference character 100. Other embodiments of fire extinguishers in accordance with the disclosure, or aspects thereof, are provided in FIGS. 2-3, as will be described. The systems and methods described herein can be used for fire extinguishing in aerospace applications, for example.

The fire extinguisher 100 includes a main dome 102 surrounding an interior. An internal plate 104 is mounted inside the interior of the main dome, dividing the interior into an internal space housing agent 106 and a secondary internal space 108. The volume of the internal space housing agent 106 may be less than, greater than or equal to that of volume 108. The internal space housing agent 106 and the secondary internal space 108 are both pressurized above ambient. The secondary internal space 108 can be free of agent. The internal plate 104 is attached to the main dome 102, e.g. internally welded or otherwise sealed. The internal plate 104 and the main dome 102 include stainless steel or any other suitable material including but not limited to titanium, aluminum, or other metallic or non-metallic materials or composites.

One or more discharge outlets 110 are positioned closer to the internal plate 104 than to the apex 112 of the main dome 102 opposite the internal plate 104. The discharge outlets 110 are configured to discharge laterally or above relative to an axis of symmetry A of the main dome 102 and the internal plate 104, i.e., discharge outlets 110 discharge along or approximately along the equator E of main dome 102. The discharge outlets 110 are positioned to discharge all or almost all of the agent without a dip-tube extending into the interior of the main dome 102. With the discharge outlets 110 proximate the bottom of the internal space housing agent 106, all or almost all of the agent can be discharged through one or all of the outlets 110 even though the discharge outlets 110 are well above the bottom of the main dome 102 and do not require a dip-tube like conventional fire extinguishers. Although shown and described in the exemplary context showing two discharge outlets 110, those skilled in the art will readily appreciate that any suitable number of discharge outlets, including one, can be used without departing from the scope of this disclosure.

The internal plate 104 divides the interior of the main dome 102 in half, i.e. into hemispheres or semi-cylinders. However, those skilled in the art will readily appreciate that the internal plate 104 can be positioned to divide the interior of the main dome unevenly without departing from the scope of this disclosure. The secondary internal space 108 is pressurized to less than, greater than, or equal to the total pressure of the internal space housing agent 106. Pressure equalization reduces the strength requirement for the internal plate 104. The combined pressure equalization and internal plate design strength are such that all structures are supported throughout the temperature range of the extinguisher. The internal plate 104 optionally includes a burst disc 114 configured to rupture when agent is discharged from the internal space housing agent 106 to equalize pressure across the internal plate 104. One or more mounting lugs 116 can be mounted to the main dome 102 opposite the internal space housing agent 106, so fire extinguisher 100 can readily be floor mounted. One or more mounting lugs 116 can be mounted to the main dome 102 on the dome housing agent 106, so fire extinguisher 100 can readily be hung.

The main dome 102 can be spherical as shown in FIG. 2, based on the cross-section schematically shown in FIG. 1. It is also contemplated that the main dome can be cylindrical as shown in FIG. 3, based on the cross-section schematically shown in FIG. 1. The cylindrical orientation in FIG. 3 is horizontal, however any suitable vertical orientation can be used as well. For example, an upright cylinder can be divided as described above, similar to the spherical configuration shown in FIG. 2 but elongated vertically into a cylindrical form.

A method of fire extinguishing includes storing fire extinguishing agent at pressure inside a main dome, e.g., main dome 102, of a fire extinguisher wherein a first internal space inside the main dome houses the agent, e.g., internal space housing agent 106. A secondary internal space, e.g., secondary internal space 108, inside the main dome is pressurized to balance pressure across an internal plate, e.g., internal plate 104, that separates the internal space housing agent from the secondary internal space. The method also includes discharging all or almost all of the agent through one or more outlet fittings, e.g., outlet fittings 110, laterally. The method can include rupturing a burst disc, e.g., burst disc 114, while discharging the agent from the internal space housing agent to equalize pressure across the internal plate to render the main dome inert after discharging stops.

Those skilled in the art will readily appreciate that the internal plate and pressure in the main dome in conjunction with can be configured such that the plate size, shape, thickness, and material properties can neutralize the stress of the internal plate, provide the required strength to contain the pressurized agent throughout the intended temperature range.

The methods and systems of the present disclosure, as described above and shown in the drawings, provide for fire extinguishers with superior properties including mounting lugs that can be located near the bottom of the fire extinguisher, enabling mounting on a floor structure without additional support structures, while the relative position of the discharge outlets can maximize usage of the extinguishing agent. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A fire extinguisher comprising:
a main dome surrounding an interior; and
an internal plate mounted inside the interior of the main dome, dividing the interior into an internal space housing agent and a secondary internal space, wherein the internal space housing agent and the secondary internal space are both pressurized above ambient.

2. A fire extinguisher as recited in claim 1, wherein the secondary internal space is free of agent.

3. A fire extinguisher as recited in claim 1, wherein the internal plate is sealed to the main dome.

4. A fire extinguisher as recited in claim 1, wherein the internal plate and the main dome includes at least one of stainless steel, titanium, aluminum, composite material, or non-metallic material.

5. A fire extinguisher as recited in claim 1, wherein the main dome is spherical.

6. A fire extinguisher as recited in claim 1, wherein the main dome is cylindrical.

7. A fire extinguisher as recited in claim 1, further comprising a discharge outlet positioned closer to the internal plate than to an apex of the main dome opposite the internal plate.

8. A fire extinguisher as recited in claim 7, wherein the discharge outlet is configured to discharge substantially laterally relative to an axis of symmetry of the main dome and the internal plate.

9. A fire extinguisher as recited in claim 1, wherein the internal plate divides the interior of the main dome.

10. A fire extinguisher as recited in claim 1, wherein the secondary internal space is pressurized to reduce pressure differential between the internal space housing agent and the secondary internal space.

11. A fire extinguisher as recited in claim 1, wherein the internal plate includes a burst disc configured to rupture when agent is discharged from the internal space housing agent to equalize pressure across the internal plate.

12. A fire extinguisher as recited in claim 1, further comprising one or more mounting lugs mounted to the main dome opposite the internal space housing agent.

13. A fire extinguisher as recited in claim 1, further comprising a discharge outlet positioned to discharge all or almost all of the agent without a dip-tube extending into the interior of the main dome.

14. A method of fire extinguishing comprising:
storing fire extinguishing agent at pressure inside a main dome of a fire extinguisher wherein a first internal space inside the main dome houses the agent and a secondary internal space inside the main dome is pressurized to reduce pressure differential across an internal plate that separates the internal space housing agent from the secondary internal space; and
discharging all or almost all of the agent through one or more outlet fittings laterally.

15. A method as recited in claim 14, further comprising rupturing a burst disc while discharging the agent from the internal space housing agent to equalize pressure across the internal plate to render the main dome inert after discharging stops.
